(19) United States
(12) Patent Application Publication
(10) Pub. No.: US 2023/0263198 A1
(43) Pub. Date: Aug. 24, 2023

(54) FOOD PRODUCTS WITH STABLE GREEN COLOR

(71) Applicant: Campbell Soup Company, Camden, NJ (US)

(72) Inventors: Nymisha Sowgandika Ravindranath, Haddonfield, NJ (US); Valerie Giuffre Price, Wynnewood, PA (US); Jayne Lillian Zurek, Philadelphia, PA (US); Hye Won Yeom, Mount Laurel, NJ (US)

(21) Appl. No.: 18/165,735

(22) Filed: Feb. 7, 2023

Related U.S. Application Data
(60) Provisional application No. 63/307,290, filed on Feb. 7, 2022.

(51) Int. Cl. A23L 5/43; A23L 23/00; A23L 29/10; A23L 3/005; A23L 35/00

(52) U.S. Cl. CPC A23L 5/43; A23L 23/00; A23L 29/10; A23L 3/005; A23L 35/10

(57) ABSTRACT

Embodiments herein relate to food products with stable green color and methods of making the same. In an embodiment, a method of making a food product with stable green color herein includes transferring chlorophyll from an aqueous phase to a lipid phase within the food product, forming an emulsion including the lipid phase, and heating the food product including the emulsion. In an embodiment, a sealed food product is included having a container and a food product composition within the container. The food product composition including a stabilized emulsion. The stabilized emulsion can include a lipid phase and chlorophyll, wherein at least 50 wt. percent of the chlorophyll is disposed within the lipid phase of the stabilized emulsion and wherein the food product composition is hermetically sealed within the container. Other embodiments are also included herein.

This application claims the benefit of U.S. Provisional Application No. 63/307,290, filed Feb. 7, 2023, the content of which is herein incorporated by reference in its entirety.

### FIELD

Embodiments herein relate to food products with stable green color and methods of making the same.

### BACKGROUND

Freshness of food is an important quality consumers consider when deciding what foods to purchase and consume. A variety of factors are typically used to determine the freshness of a food product. For example, consumers may consider the expiration date on the package as well as the smell, appearance, or color of the food product. If a consumer perceives the food product is not fresh, then the consumer is less likely to purchase and consume the product.

Consumer perception of food freshness can present problems for food manufacturers of prepared food products containing chlorophyll. This is because the processing of food products can adversely affect the natural green color of chlorophyll. When processed, the bright green color can become a grayish, yellow-green color that is inconsistent with a perception of fresh foods.

### SUMMARY

Embodiments herein relate to food products with stable green color and methods of making the same. In a first aspect, a method of making a food product with stable green color can be included, the method including transferring chlorophyll from an aqueous phase to a lipid phase within the food product, forming an emulsion including the lipid phase, and heating the food product including the emulsion.

In a second aspect, in addition to one or more of the preceding or following aspects, or in the alternative to some aspects, the method can further include stabilizing the emulsion.

In a third aspect, in addition to one or more of the preceding or following aspects, or in the alternative to some aspects, the method can further include stabilizing the emulsion with a stabilizing agent.

In a fourth aspect, in addition to one or more of the preceding or following aspects, or in the alternative to some aspects, the stabilizing agent can include a hydrocolloid.

In a fifth aspect, in addition to one or more of the preceding or following aspects, or in the alternative to some aspects, the emulsion can include an emulsifier.

In a sixth aspect, in addition to one or more of the preceding or following aspects, or in the alternative to some aspects, the emulsifier can include avocado phospholipids.

In a seventh aspect, in addition to one or more of the preceding or following aspects, or in the alternative to some aspects, the food product can include a green salsa product.

In an eighth aspect, in addition to one or more of the preceding or following aspects, or in the alternative to some aspects, the food product can include a shelf-stable green salsa product.

In a ninth aspect, in addition to one or more of the preceding or following aspects, or in the alternative to some aspects, the food product can include a green soup product.

In a tenth aspect, in addition to one or more of the preceding or following aspects, or in the alternative to some aspects, the heating can be sufficient to achieve a 5.0-log reduction of a foodborne microorganism.

In an eleventh aspect, in addition to one or more of the preceding or following aspects, or in the alternative to some aspects, wherein less than 50 wt. percent of the chlorophyll converts to pheophytin after 60 days at room temperature.

In a twelfth aspect, in addition to one or more of the preceding or following aspects, or in the alternative to some aspects, wherein less than 30 wt. percent of the chlorophyll converts to pheophytin after 60 days at room temperature.

In a thirteenth aspect, in addition to one or more of the preceding or following aspects, or in the alternative to some aspects, the method can further include sealing the food product into a container, wherein sealing the food product into the container can be conducted before the operation of the heating.

In a fourteenth aspect, in addition to one or more of the preceding or following aspects, or in the alternative to some aspects, the container can include a translucent glass or polymer.

In a fifteenth aspect, in addition to one or more of the preceding or following aspects, or in the alternative to some aspects, the method can further include transferring at least 50 wt. percent of total chlorophyll within the food product from the aqueous phase to the lipid phase.

In a sixteenth aspect, in addition to one or more of the preceding or following aspects, or in the alternative to some aspects, the method can further include combining other ingredients with the emulsion to form the food product.

In a seventeenth aspect, a sealed food product can be included having a container, and a food product composition, the food product composition can include a stabilized emulsion, the stabilized emulsion can include a lipid phase, chlorophyll, wherein at least 50 wt. percent of the chlorophyll can be disposed within the lipid phase of the stabilized emulsion, wherein the food product composition can be hermetically sealed within the container.

In an eighteenth aspect, in addition to one or more of the preceding or following aspects, or in the alternative to some aspects, the food product composition can include a lipid content of 2 to 20 percent by weight.

In a nineteenth aspect, in addition to one or more of the preceding or following aspects, or in the alternative to some aspects, the lipid phase can include a vegetable oil.

In a twentieth aspect, in addition to one or more of the preceding or following aspects, or in the alternative to some aspects, the emulsion can include an emulsifier.

In a twenty-first aspect, in addition to one or more of the preceding or following aspects, or in the alternative to some aspects, the emulsifier can include avocado phospholipids.

In a twenty-second aspect, in addition to one or more of the preceding or following aspects, or in the alternative to some aspects, the stabilized emulsion can include a stabilizing agent.

In a twenty-third aspect, in addition to one or more of the preceding or following aspects, or in the alternative to some aspects, the stabilizing agent can include a hydrocolloid.

In a twenty-fourth aspect, in addition to one or more of the preceding or following aspects, or in the alternative to some aspects, the hydrocolloid can include xanthan gum.

In a twenty-fifth aspect, in addition to one or more of the preceding or following aspects, or in the alternative to some aspects, the sealed food product can be a green salsa product.

In a twenty-sixth aspect, in addition to one or more of the preceding or following aspects, or in the alternative to some aspects, the sealed food product can be a shelf-stable green salsa product.

In a twenty-seventh aspect, in addition to one or more of the preceding or following aspects, or in the alternative to some aspects, the sealed food product can be a green soup product.

In a twenty-eighth aspect, in addition to one or more of the preceding or following aspects, or in the alternative to some aspects, the food product composition can have a pH of 6 or less.

In a twenty-ninth aspect, in addition to one or more of the preceding or following aspects, or in the alternative to some aspects, wherein less than 50 percent of the chlorophyll converts to pheophytin and/or pheophorbide after 60 days at room temperature.

In a thirtieth aspect, in addition to one or more of the preceding or following aspects, or in the alternative to some aspects, wherein less than 30 percent of the chlorophyll converts to pheophytin and/or pheophorbide after 60 days at room temperature.

In a thirty-first aspect, in addition to one or more of the preceding or following aspects, or in the alternative to some aspects, the container can include a translucent glass or polymer.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of chlorophyll transfer into a lipid phase in accordance with various embodiments herein.

FIG. 2 is a diagram illustrating the degradation of chlorophyll in accordance with various embodiments herein.

FIG. 3 is a schematic view of a food product in accordance with various embodiments herein.

FIG. 4 is a schematic view of a food product in accordance with various embodiments herein.

FIG. 5 is a schematic view of an emulsifier in an emulsion in accordance with various embodiments herein.

FIG. 6 is a flowchart depicting a method in accordance with various embodiments herein.

FIG. 7 is a flowchart depicting a method in accordance with various embodiments herein.

FIG. 8 is a flowchart depicting a method in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Maintaining the natural green color of chlorophyll in food products is important for consumers perceiving the food product as being fresh. Embodiments herein provide a way to protect and preserve the naturally bright green color of chlorophyll containing food products. It has been discovered herein that the naturally bright green color of chlorophyll can be preserved during processing steps and/or shelf storage by transferring chlorophyll contained in an aqueous phase into a lipid phase. For example, chlorophyll can be transferred to a lipid phase and then an emulsion can be formed prior to heating or otherwise processing the food product containing the emulsion. By transferring the chlorophyll to the lipid phase the chlorophyll is protected in the emulsion and the bright green color preserved.

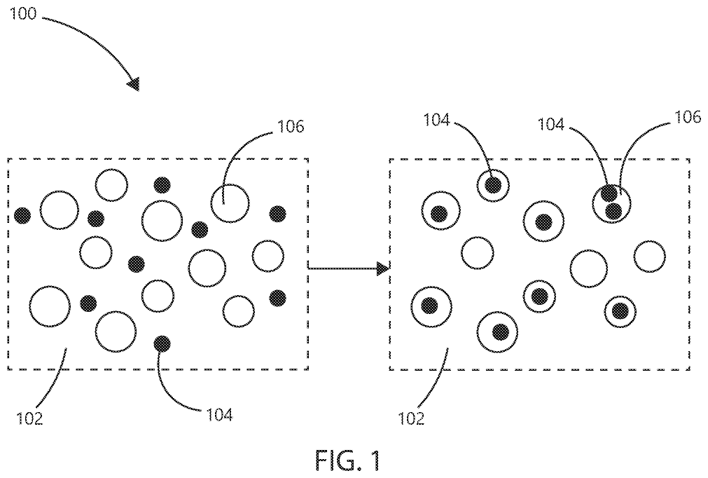

Referring now to FIG. 1, a schematic view is shown of chlorophyll transfer 100 in accordance with various embodiments herein. Food containing chlorophyll, such as may be provided by vegetables, can be initially prepared using a variety of techniques. For example, the food can be rinsed, washed, chopped, diced, sliced, minced, ground, etc. After initial preparation steps, a lipid can be added to the food to create a mixture. The lipid can include a variety of fats or oils discussed in more detail below. The mixture can include an aqueous phase 102 containing chlorophyll 104 and a lipid phase 106. The mixture can be processed to transfer the chlorophyll 104 from the aqueous phase 102 to the lipid phase 106 as FIG. 1 illustrates. The mixture can be processed by stirring, shaking, whisking, or agitating the mixture. Once the chlorophyll 104 has been transferred into the lipid phase 106 to a sufficient degree, the mixture can be homogenized to form an emulsion and subsequently heated. In some embodiments, operations of transferring the chlorophyll and forming an emulsion can be performed simultaneously while in other embodiments the operations may be performed sequentially.

In various embodiments, an amount of chlorophyll is transferred to the lipid phase that is sufficient to maintain a desirable green color in the end food product. The specific amount transferred can vary, but in many cases is less than 100% of the chlorophyll present. In various embodiments, at least 30 wt. percent of the total chlorophyll 104 within the food product can be transferred from the aqueous phase 102 to the lipid phase 106. In some embodiments, the amount of chlorophyll 104 transferred can include greater than or equal to 30 wt. percent, 40 wt. percent, 50 wt. percent, 60 wt. percent, 70 wt. percent, 80 wt. percent, or 90 wt. percent, or can be an amount falling within a range between any of the foregoing. In some embodiments, the amount of chlorophyll transferred from the aqueous phase 102 to the lipid phase 106 can be at least 50 wt. percent.

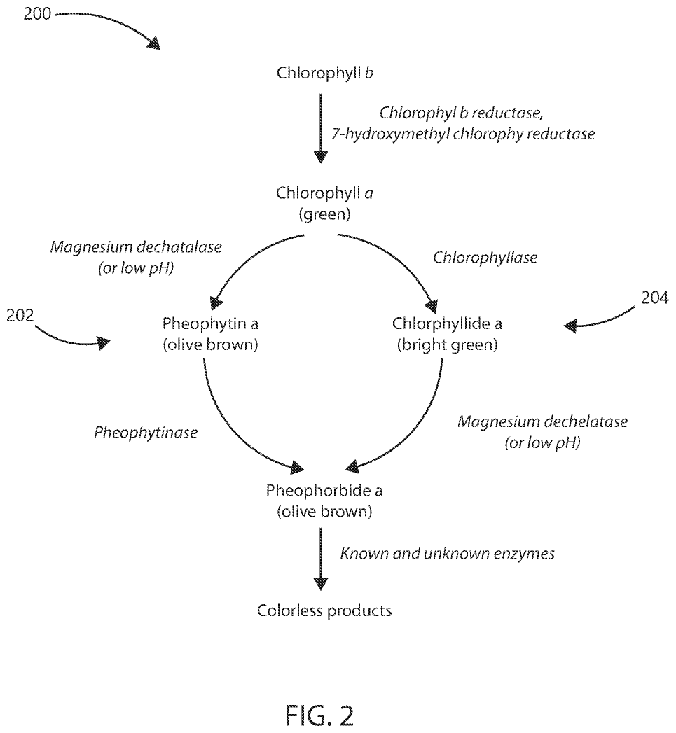

Referring now to FIG. 2, a diagram is shown illustrating the degradation of chlorophyll 200 in accordance with various embodiments herein. Chlorophyll can begin to degrade when the food product containing chlorophyll is chopped, cooked, frozen, or otherwise exposed to a low pH environment. It should be noted, that changes in pH are believed to be one of the major causes of chlorophyll degradation in many scenarios. This is due to the release of intracellular acids and enzymes within the food product contacting the chlorophyll-protein complexes. Once chlorophyll begins to degrade, it follows one of two pathways 202, 204. Following pathway 202, chlorophyll forms pheophytin a which has an olive brown color due to the loss of the magnesium ion by the magnesium dechelatase enzyme (Mg-dechelatase) and the subsequent removal of the phytol chain results in the formation of pheophorbide a which also has an olive brown color. In contrast, following pathway 204, chlorophyll forms chlorophyllide a which has a bright green color due to the removal of the phytol chain from the chlorophyll catalyzed by the chlorophyllase enzyme and the subsequent removal of the magnesium ion results in the formation of pheophorbide a which has an olive brown color. Ultimately, the pheophorbide a formed in pathways 202 and 204 is converted to colorless products due to the cleavage of the porphyrin ring.

However, as a result of operations applied herein, in various embodiments herein less than 70 wt. percent of the chlorophyll contained in the food product will be converted to pheophytin after 60 days at room temperature. In some embodiments, the amount of chlorophyll that converts to pheophytin after 60 days at room temperature can be less than or equal to 10 wt. percent, 20 wt. percent, 30 wt. percent, 40 wt. percent, 50 wt. percent, 60 wt. percent, or 70 wt. percent, or can be an amount falling within a range between any of the foregoing. In some embodiments, the amount of pheophytin present after 60 days at room temperature can be from 30 to 50 wt. percent.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method of making a food product is included. The method can include transferring chlorophyll from the aqueous phase to the lipid phase and forming an emulsion. Optionally, the method can include adding an emulsifier and stabilizing agent to form the emulsion.

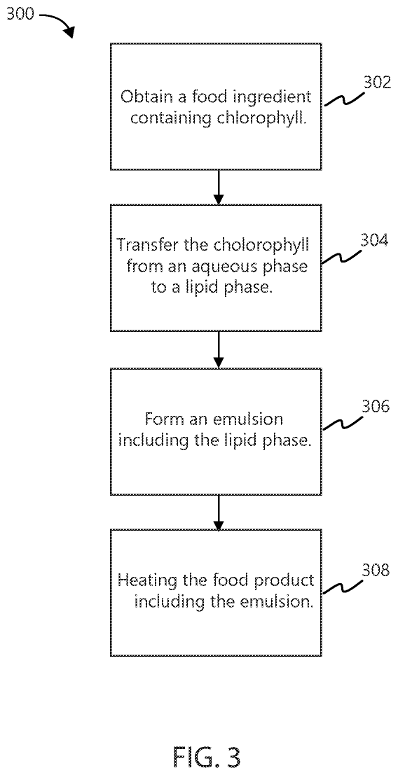

However, it will be appreciated that food products herein can be manufactured using various techniques. Referring now to FIG. 3, a flowchart depicting a method 300 is shown in accordance with various embodiments herein. FIG. 3 shows a method 300 of making a food product with stable green color. The method 300 includes obtaining a food product ingredient or ingredients containing chlorophyll at 302. Food product ingredients can include, but are not limited to, avocadoes, spinach, lettuce, kale, broccoli, asparagus, brussels sprouts, parsley, cabbage, celery, peas, bell peppers, etc. In some cases, food product ingredients herein can also include preparations or extracts containing chlorophyll, chlorophyll containing components, or chlorophyll itself. The method 300 further includes transferring chlorophyll from an aqueous phase to a lipid phase at 304. In some cases, the operation of transferring the chlorophyll from the aqueous phase to the lipid phase can include combining the aqueous phase and the lipid phase and processing the two phases (such as by agitating, shaking, stirring, mixing, blending, or the like) the aqueous and lipid phase together to form a mixture wherein substantial transfer of chlorophyll to a lipid phase has occurred.

In various embodiments, the method 300 further includes forming an emulsion including the lipid phase at 306. In some embodiments, a portion of the aqueous phase may be removed after chlorophyll transfer and prior to forming an emulsion. In other embodiments, the aqueous phase is maintained. In some embodiments, an additional component such as a processing aid, emulsifier or stabilizer can be added, but in other embodiments is omitted. In some embodiments, the emulsion can be formed by homogenizing the aqueous and lipid phase. For example, the emulsion can be formed using a wet mill or another piece of processing equipment.

The method 300 further includes heating the food product including the emulsion at 308. In some embodiments, the heating of the food product can be sufficient to result in a sterilized or pasteurized food product. In some embodiments, sterilization and/or pasteurization can include retort cooking. In some embodiments, sterilization and/or pasteurization can include microwave and/or radiofrequency processing. In some embodiments, sterilization or pasteurization can include heating the food product to a temperature of at least about 140, 145, 150, 155, 160, 165, 170, 175, 180, 185, 190, 195, 200, 205, 210, 220, 230, 240, 250, 275, or 300 or more degrees Fahrenheit for a period of time. In some embodiments, the temperature can be in a range wherein any of the foregoing temperatures can serve as the lower or upper bound of the range, provided that the upper bound is greater than the lower bound. The period of time can vary, depending on the temperature and other factors, but in some embodiments, can be at least 30 seconds, 1 minute, 2 minutes, 3 minutes, 4 minutes, 5 minutes, 7 minutes, 10 minutes, 15 minutes, 20 minutes, 25 minutes, 30 minutes, 40 minutes, 60 minutes, or more. In some embodiments, the time can be in a range wherein any of the foregoing times can serve as the lower or upper bound of the range, provided that the upper bound is greater than the lower bound. In some embodiments, multiple stages of heating can be included, such as initial heating during processing and later heating for sterilization or pasteurization purposes. In some embodiments, the food product can be sealed within a food container or package prior to final heating so as to result in a shelf-stable food product.

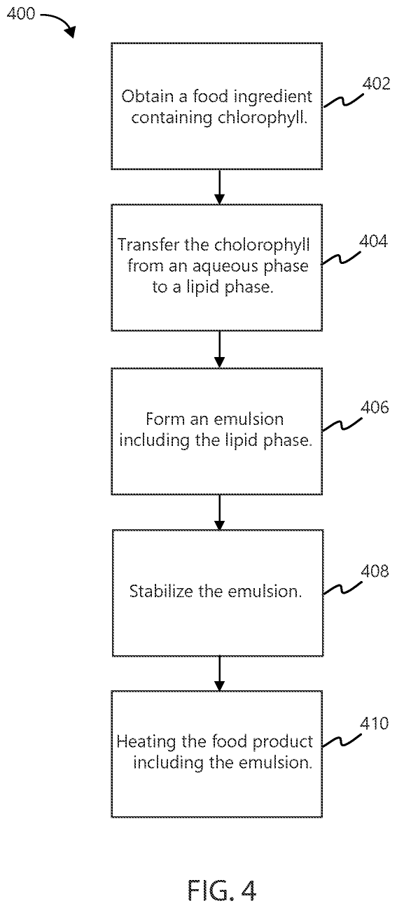

Referring now to FIG. 4, a flowchart depicting a method in accordance with various embodiments herein. FIG. 4 shows a method 400 of making a food product with stable green color. The method 400 includes obtaining a food ingredient containing chlorophyll at 402. Food ingredients can include, but are not limited to, avocadoes, spinach, lettuce, kale, broccoli, asparagus, brussels sprouts, parsley, cabbage, celery, peas, bell peppers, preparations or extracts containing chlorophyll, chlorophyll containing components, or chlorophyll itself, and the like. The method 400 further includes transferring chlorophyll from an aqueous phase to a lipid phase within the food product at 404. In some cases, the operation of transferring the chlorophyll from the aqueous phase to the lipid phase can include combining the aqueous phase and the lipid phase and processing the two phases (such as by agitating, shaking, stirring, mixing, blending, or the like) the aqueous and lipid phase together to form a mixture wherein substantial transfer of chlorophyll to a lipid phase has occurred.

The method 400 further includes forming an emulsion including the lipid phase at 406. In some embodiments, the emulsion can be formed by homogenizing the aqueous and lipid phase. For example, the emulsion can be formed using a wet mill.

The method 400 further includes stabilizing the emulsion at 408. In some embodiments, the emulsion can be stabilized using a stabilizing agent. In some embodiments, the stabilizing agent can include a hydrocolloid (xanthan gum, guar gum, carrageenan, cellulose, etc.) discussed in greater detail below.

The method 400 further includes heating the food product including the emulsion at 410. In some embodiments, the food product can be sterilized or pasteurized using heat treatment. In some embodiments, sterilization and/or pasteurization can include retort cooking. This process is discussed in more detail above.

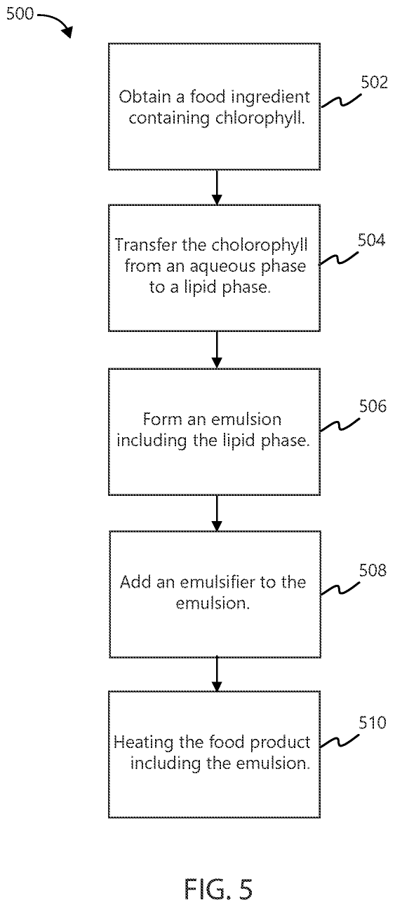

Referring now to FIG. 5, a flowchart depicting a method in accordance with various embodiments herein. FIG. 5 shows a method 500 of making a food product with stable green color. The method 500 includes obtaining a food product containing chlorophyll at 502. Food products can include, but are not limited to, avocadoes, spinach, lettuce, kale, broccoli, asparagus, brussels sprouts, parsley, cabbage, celery, peas, bell peppers, etc. The method 500 further includes transferring chlorophyll from an aqueous phase to a lipid phase within the food product at 504. The operation of transferring the chlorophyll from the aqueous phase to the lipid phase can include combining the aqueous phase and the lipid phase and agitating or stirring the aqueous and lipid phase together to form a mixture.

The method 500 further includes forming an emulsion including the lipid phase at 506. In some embodiments, the emulsion can be formed by homogenizing the aqueous and lipid phase. For example, the emulsion can be formed using a wet mill.

The method 500 further includes adding an emulsifier to the emulsion at 508. In some embodiments, the emulsifier can include mono and diglycerides, phospholipids, fatty acid derivatives, polyglycerol polyricinoleate (PGPR), and ammonium phosphatide (AMP) discussed in greater detail below. In some embodiments, the emulsifier can be added prior the operation of forming the emulsion 506, and in some embodiments after, or even before and after.

The method 500 further includes heating the food product including the emulsion at 510. In some embodiments, the food product can be sterilized or pasteurized using heat treatment. In some embodiments, sterilization and/or pasteurization can include retort cooking. This process is discussed in more detail above.

In various embodiments, any of the methods above can include heating the food product sufficient to achieve at least a 3.0-log reduction of a foodborne microorganism. In some embodiments, heating of the food product can be sufficient to achieve at least a 3.0-log reduction, 4.0-log reduction, 5.0-log reduction, 6.0-log reduction, or 7.0-log reduction, or can be an amount falling within a range between any of the foregoing. In some embodiments, heating the food product can be sufficient to achieve a 5.0-log reduction of a foodborne microorganism.

In some embodiments, the food product of any of the above methods can be placed into a food container. In some embodiments, the food product can be hermetically sealed within the food container. In some embodiments, the food product can be sealed into the food container prior to the operation of heating the food product. In other embodiments, the food product can be sealed into the food container after the operation of heating the food product. Food containers can include, but are not limited to, cans, jars, tubs, boxes, pouches, bottles, glasses, and the like. The food containers can be opaque, translucent, transparent, or the like.

In various embodiments, any of the above methods can include less than 70 wt. percent of the chlorophyll being converting to pheophytin after 60 days at room temperature. In some embodiments, the amount of chlorophyll converting to pheophytin after 60 days at room temperature can include less than or equal to 10 wt. percent, 20 wt. percent, 30 wt. percent, 40 wt. percent, 50 wt. percent, 60 wt. percent, or 70 wt. percent, or can be an amount falling within a range between any of the foregoing. In some embodiments, the amount of pheophytin after 60 days at room temperature can be from 30 to 50 wt. percent.

### Food Product

Embodiments herein include various food products. For example, food products herein can include, but are not limited to, green soup products, green salsa products, green vegetable-based products, green baby food, green sauces. In various embodiments, the green color of the food products can be derived from the food product containing chlorophyll. In various embodiments, the food products can include sealed, shelf-stable food products.

In various embodiments, the food product composition can include a lipid content of less than 2, 4, 6, 8, 10, 12, 14, 16, 18, 20, 22, 24, 26, 28, 30 percent by weight. For example, the food product compositions can include a lipid content of 2 to 20 percent by weight.

In various embodiments, the food product composition has a pH less than 2, 3, 4, 5, 6, 7. For example, the food product composition can have a pH of 6.

Some food products herein can contain other ingredients including, but not limited to, fats and oils (vegetable oil, soybean oil, canola oil, olive oil, ghee, butter, coconut oil, pumpkin seed oil, linseed oil, grape seed oil, sesame oil, avocado oil, sunflower oil, peanut oil, corn oil, palm oil, flaxseed oil, hemp seed oil, walnut oil, etc.), hydrocolloids (xanthan gum, guar gum, carrageenan, cellulose, agar-agar, konjac gum, alginate, locust bean gum, gelatin, etc.), emulsifiers (mono and diglycerides, phospholipids, fatty acid derivatives, polyglycerol polyricinoleate (PGPR), ammonium phosphatide (AMP), etc.), salt, vinegar, sugar, spices and flavors.

In various embodiments herein, food products lack chemical additives for preserving green color and/or lack green food dyes. For example, food products herein can lack zinc compound additives, copper compound additives, exogenous anti-oxidants, and the like. In various embodiments, food products can contain less than 0.1, 0.01, 0.001, or 0.0001 wt. percent of chemical additives for preserving green color and/or lack green food dyes.

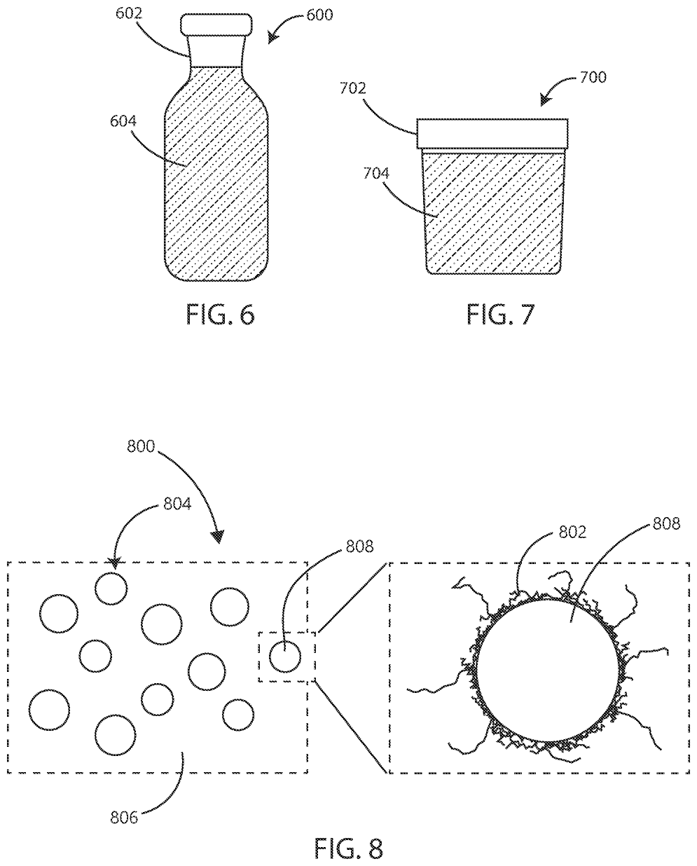

Referring now to FIG. 6, a schematic view is shown of a food product 600 in accordance with various embodiments herein. The food product 600 can include a container 602 and food product 604 disposed within the container 602. The food product 604 can be a variety of food products. For example, the food product 604 can be any of the food products described above. The container 602 can include, but is not limited to, cans, jars, tubs, boxes, pouches, bottles, glasses, and the like. The container 602 can be opaque, translucent, transparent, or the like. In various embodiments, the container 602 is made from translucent glass or polymer.

Referring now to FIG. 7, a schematic view is shown of a food product 700 in accordance with various embodiments herein. The food product 700 can include a container 702 and a food material 704 disposed within the container 702. The container 702 can include, but is not limited to, cans, jars, tubs, boxes, pouches, bottles, glasses, and the like. The container 702 can be opaque, translucent, transparent, or the like. In various embodiments, the container 702 is made from translucent glass or polymer. The food material 704 can be any of the food products described above.

### Stabilizing Agents and Emulsifiers

Various embodiments herein include a stabilizing agent. Stabilizing agents can act to stabilize the emulsion of the food product by preventing the separation of the lipids and water-soluble liquids.

In some embodiments, the stabilizing agent can include hydrocolloids. Exemplary hydrocolloids can include xanthan gum, guar gum, carrageenan, cellulose, agar-agar, konjac gum, alginate, locust bean gum, pectin, gum Arabic, and gelatin. The amount of the stabilizing agent can vary depending on the specific stabilizing agent used and the type of food product being created. In some embodiments, the amount of stabilizing agent can be greater than or equal to 0.01, 0.2, 0.4, 0.6, 0.8, or 1.0 wt. percent. In some embodiments, the amount can be less than or equal to 5, 4, 3, 2, or 1.0 wt. percent. In some embodiments, the amount can fall within a range of 0.01 to 5.00 wt. percent or 0.80 to 1.80 wt. percent.

Various embodiments herein include an emulsifier. Further details about the emulsifier are provided as follows. However, it will be appreciated that this is merely provided by way of example and that further variations are contemplated herein.

The food products described above can include an emulsifier. Emulsifiers act to allow lipids and water-soluble liquids blend together to create a stable emulsion. The emulsifier acts to stabilize the food product while reducing the amount of crystallization and separation that may occur.

In some embodiments, emulsifiers can include fatty acid derivatives. Exemplary fatty acid derivatives can include polyglycerol esters (PGE), polysorbates, stearoyl lactylates, propylene glycol esters (PGMS) and sucrose esters. In some embodiments, emulsifiers can include phospholipids. Exemplary phospholipids can include avocado phospholipids, asparagus phospholipids, celery phospholipids, spinach phospholipids, lettuce phospholipids and lecithin. In some embodiments, emulsifiers can include mono and diglycerides. Exemplary mono and diglycerides can include diacetyl tartaric acid ester (DATEM), succinylated monoglycerides (SMG), ethoxylated monoglycerides (EMG), glycerol monostearate (GMS), lactylated monoglycerides (LacMG), acetylated monoglycerides (AcMG), and propylene glycol monoesters (PGME). In some embodiments, emulsifiers can include polyglycerol polyricinoleate (PGPR) and ammonium phosphatide (AMP).

The amount of the emulsifier used can vary depending on the specific emulsifier and the type of food product being created. However, in some embodiments, the amount of emulsifier used can be greater than or equal to 0.01, 0.2, 0.4, 0.6, 0.8, or 1.0 wt. percent. In some embodiments, the amount can be less than or equal to 5, 4, 3, 2, or 1.0 wt. percent. In some embodiments, the amount can fall within a range of 0.01 to 5.00 wt. percent or 0.80 to 1.80 wt. percent.

Referring now to FIG. 8, a schematic view is shown of an emulsifier 802 in an emulsion 800 in accordance with various embodiments herein. The presence of the emulsifier 802 in the emulsion enhances the stability of the emulsion 800 due to the maintenance of an oil droplet network 804 believed to result from mechanisms such as depletion flocculation and modification of the emulsion's continuous phase 806 viscosity, both of which serve to prevent the oil droplets 808 from aggregating.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method of making a food product with stable green color comprising:
transferring chlorophyll from an aqueous phase to a lipid phase within the food product;
forming an emulsion including the lipid phase; and
heating the food product including the emulsion.

2. (canceled)

3. The method of claim 1, further comprising stabilizing the emulsion with a stabilizing agent.

4. The method of claim 3, the stabilizing agent comprising a hydrocolloid.

5. The method of claim 1, the emulsion comprising an emulsifier, the emulsifier comprising avocado phospholipids.

6-7. (canceled)

8. The method of claim 1, the food product comprising a shelf-stable green salsa product.

9. The method of claim 1, the food product comprising a green soup product.

10. The method of claim 1, wherein the heating is sufficient to achieve a 5.0-log reduction of a foodborne microorganism.

11. (canceled)

12. The method of claim 1, wherein less than 30 wt. percent of the chlorophyll converts to pheophytin after 60 days at room temperature.

13. The method of claim 1, further comprising sealing the food product into a container, wherein sealing the food product into the container is conducted before the operation of the heating.

14. (canceled)

15. The method of claim 1, further comprising transferring at least 50 wt. percent of total chlorophyll within the food product from the aqueous phase to the lipid phase.

16. (canceled)

17. A sealed food product comprising:
a container; and
a food product composition, the food product composition comprising
a stabilized emulsion, the stabilized emulsion comprising a lipid phase;
chlorophyll, wherein at least 50 wt. percent of the chlorophyll is disposed within the lipid phase of the stabilized emulsion;
wherein the food product composition is hermetically sealed within the container.

18. The sealed food product of claim 17, the food product composition comprising a lipid content of 2 to 20 percent by weight.

19. (canceled)

20. The sealed food product of claim 17, the emulsion comprising an emulsifier.

21. The sealed food product of claim 20, the emulsifier comprising avocado phospholipids.

22. The sealed food product of claim 17, the stabilized emulsion comprising a stabilizing agent.

23. The sealed food product of claim 22, the stabilizing agent comprising a hydrocolloid.

24. The sealed food product of claim 23, the hydrocolloid comprising xanthan gum.

25. (canceled)

26. The sealed food product of claim 17, wherein the sealed food product is a shelf-stable green salsa product.

27. The sealed food product of claim 17, wherein the sealed food product is a green soup product.

28-29. (canceled)

30. The sealed food product of claim 17, wherein less than 30 percent of the chlorophyll converts to pheophytin and/or pheophorbide after 60 days at room temperature.

31. (canceled)
